(19) United States
(12) Patent Application Publication
(10) Pub. No.: US 2002/0117266 A1
(43) Pub. Date: Aug. 29, 2002

(54) Automatic roll laminator

(76) Inventor: Young-Bae Han, Seoul (KR)

Correspondence Address: Richard C. Woodbridge, Esq., Woodbridge & Associates, P.C., P.O. Box 592, Princeton, NJ, 08542, US

(21) Appl. No.: 09/892,986

(22) Filed: Jun. 27, 2001

(30) Foreign Application Priority Data
Feb. 27, 2001 (KR) 2001-5112

(51) Int. Cl. B32B 31/00

(52) U.S. Cl. 156/556; 156/583.1

(57) ABSTRACT

The present invention relates to a roll laminator for coating synthetic resins such as polyethylene to a kind of a paper for being automatically supplied continuously. The automatic roll laminator of the present invention comprises: a body a supply inlet formed at the front of the body for supplying a material to be coated, an outlet formed at the rear of the body for discharging the coated material, a supply roller disposed at one side of the supply inlet for feeding the material into the body, a film drawing roller for drawing a film mounted to the inside of the body to the both sides of material to be coated, a heating roller and a pressing roller for heating and pressing the film to the paper, wherein a front cover and a rear cover are hinge-type coupled to one side of the front and rear portions so that they can be opened/closed in the front and rear directions, wherein said upper film drawing roller, said heating roller and said pressing roller are coupled to an upper supporting plate which is hinge-type coupled to the rear one side of the body to be upwardly slant by a predetermined degree.

### BACKGROUND OF THE INVENTION

1. Field of the Invention

The present invention relates to a roll laminator for coating synthetic resins such as polyethylene to a kind of a paper for being automatically and continuously supplied.

2. Description of the Prior Art

In general, a kind of a paper (hereinafter called a processing material) such as paper documents and photo that weak against an outer pressure must be coated with a transparent synthetic resin such as polyethylene so that the processing material can be maintained its original condition for a long time against a physical or chemical pressure.

To comply this object there have been invented many coating apparatuses for coating an insulator film to both sides of the processing material.

A conventional apparatus for coating a film to the processing material is divided into two types. A type, so called, a pouch type is that the processing material to be coated is inserted between two previously manufactured synthetic resin films thereafter passing through a heating roller and a pressing roller of the coating apparatus so that a thin layer is formed on the processing material. The other type, so called a roll type is that the roll film is disposed at the upper and lower positions of the apparatus and the processing material is inserted to there between thereby to be formed a thin film at the upper and lower surface of the processing material.

The pouch type coating apparatus has the problems that the material must be manually one by one inserted into the films which is manufactured according to the size and shape of the material to be coated and that a time for coating is increased because the material and the films can not be continuously supplied to the coating apparatus.

The roll type coating apparatus for forming the coating layer to the both sides of the material to be inserted into the roll type film, which is disposed in the coating apparatus has the problems that there must be increased a time for coating because the material must be manually supplied not continuously and the coated material by a heat fusion must be cut by an user's needs.

Furthermore, in order for the film to reach to the outlet through the heating roller, the pressing roller and the guide plate after the roll-type film is disposed at the roller in the body for coating the material, the leading plate for guiding the films must be attached to the front end portion of the films thereafter to be passed through between the heating roller and the pressing roller, which are closely disposed each other. Accordingly, the coating working must be performed manually thereby causing the working to be difficult.

Further, a static electricity is generated when the coating layer is formed to the both side of the material being passed the heating roller and the pressing roller. Accordingly, the coated material can not be correctly accumulated in order at the output tray due to the static electricity force between the materials being supplied continuously when the paper is discharged toward the discharging tray. Further, although the roll laminator mounted with an automatic cutting instrument is used, the accumulating working can not be performed to be good thereby causing the coated material to be manually rearranged and accumulated.

Furthermore, the conventional heating roller is its surface manufactured with a low-conductivity steel thereby causing a time for reaching to the predetermined temperature for forming the coated layer to the paper to be lengthen.

### SUMMARY OF THE INVENTION

The present invention has been invented to overcome the above problems, it is an object to provide an automatic roll laminator for easily disposing a roll film by a hinge-type cover for opening/closing from or to a body and by a heating roller and a pressing roller mounted at the upper and lower portion of the apparatus for detachably establishing each other.

Another object of the present invention is to provide an automatic roll laminator that can be shorten the working time by supplying a material manually and automatically.

Still other object of the present invention is to provide an automatic roll laminator that prevented a static electricity due to a heat and a pressure for forming the coating layer to a material.

To achieve the objects, an automatic roll laminator of the present invention comprising: a body having a supply inlet formed at its front for supplying a material to be coated and an outlet formed at its rear for discharging the coated material, a supply roller disposed at one side of the supply inlet for feeding the material into the body, a film drawing roller for drawing a film mounted at the inside of the body to the both sides of material to be coated, a heating roller and a pressing roller disposed at the upper and lower portions to each other for heating and pressing the film to the material, wherein said body has its front and rear side with a hinge-type front cover and a rear cover, wherein said upper film drawing roller, said heating roller and said pressing roller are coupled to an upper supporting plate which is hinge-type coupled to the rear one side of the body to be upwardly slant by a predetermined degree.

A supply tray is disposed at the corresponding position to the supply inlet of the body and a solenoid and a supply clutch are disposed at one side of the supply roller so that the material served at the supply tray is in order fed to the standby roller,

A static electricity preventing brush is disposed at the neighborhood of the upper/lower heating roller and the discharging roller for removing a static electricity generated in the material.

A temperature sensor is attached at the surface of the upper/lower heating roller for maintaining and regulating the surface temperature of the heating roller.

The pressing roller is at its one side disposed with a fixing cutter fixedly established at the upper supporting plate and with a rotating cutter rotationally established at the lower supporting plate so that the coated material can be cut according to the user's desire.

The body is its discharging outlet side disposed with a lead switch for sensing whether the cut material is fed and with a counter for counting the number of coating of the material.

The heating roller is manufactured with an aluminum.

### BRIEF DESCRIPTION OF THE DRAWINGS

FIG. 1 is a perspective view of an automatic roll laminator according to the present invention.

FIG. 2 is a perspective view for an open state of the cover according to the present invention.

FIG. 3 is a longitudinal section view for a supply tray and discharging tray according to the present invention.

FIG. 4 is a longitudinal section view for an open state of the cover according to the present invention, and FIG. 5 is a longitudinal section view for mounting a roll film in the body according to the present invention.

### DESCRIPTION OF THE PREFERRED EMBODIMENT

Now, the present invention will be in detail described with reference to the drawings.

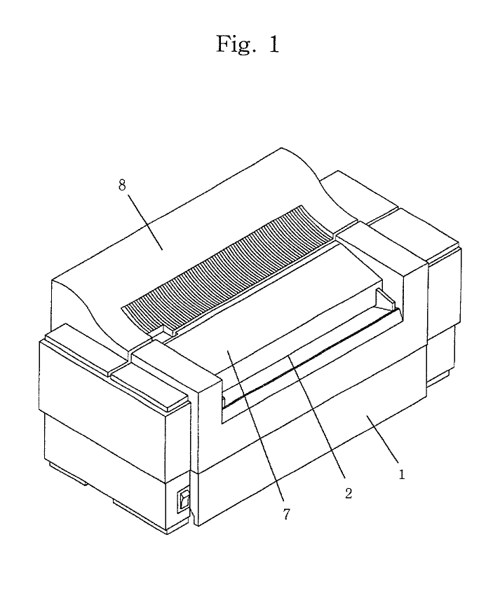

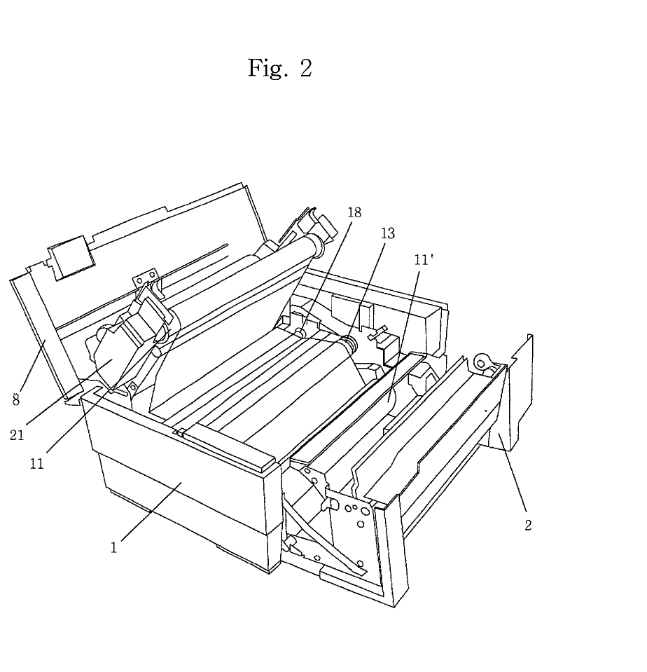

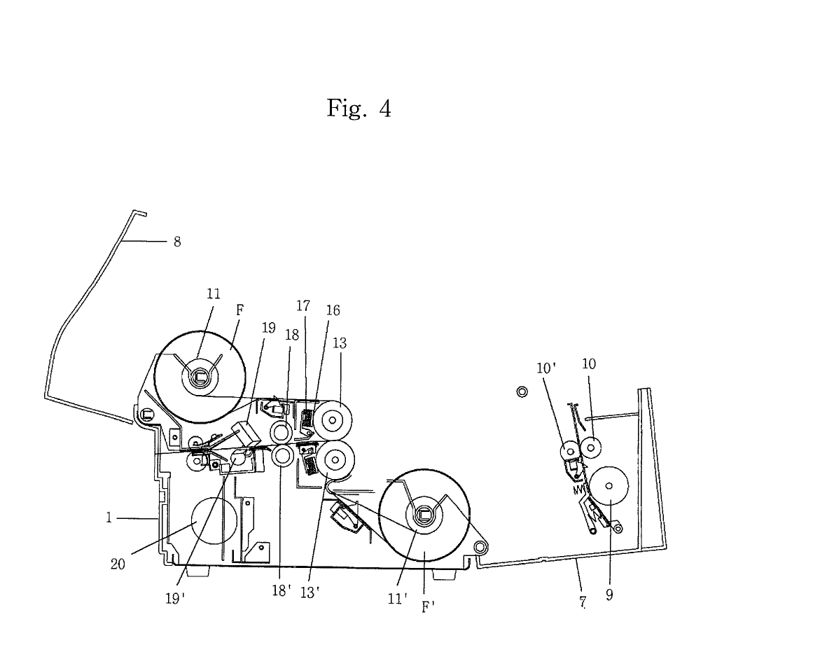

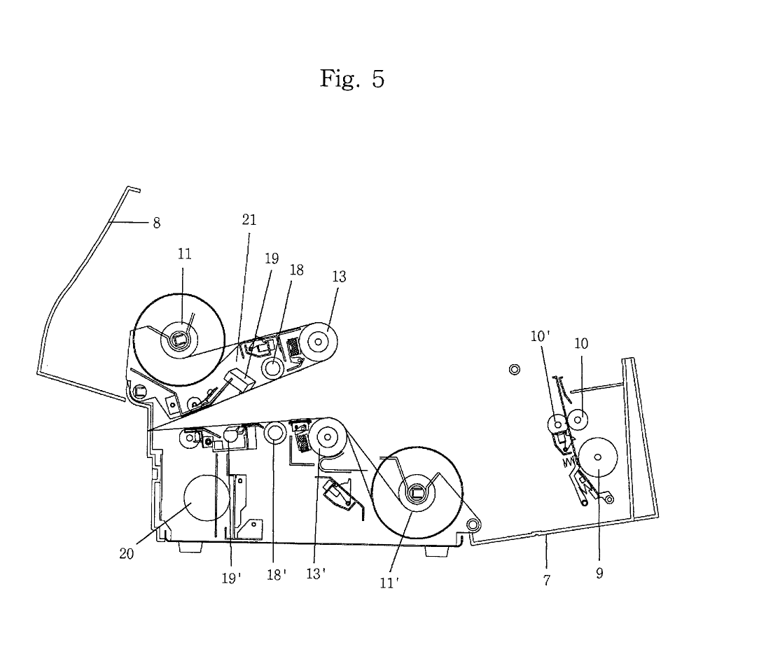

As shown in FIGS. 1-5, an automatic roll laminator for coating a kind of paper (subject to be processed)(in the specification including the claims the word “material” is used) according to the present invention comprises a body 1 and covers 7 and 8 coupled to the upper portion of the body 1 for opening/closing.

The body 1 has several buttons necessary to coat the material such as, a power supply button, a coating start button, a jam lamp and a roll film lamp. The body 1 is at the front side thereof formed with a supply inlet 2 for supplying the material to be coated. A supply tray 3 is disposed at a corresponding position to the supply inlet 2 for continuously supplying the material.

The body 1 is at the rear side thereof formed an discharging outlet 5 for discharging the coated material. A discharging tray 6 is disposed at a corresponding position to the outlet 5 for accumulating the coated material in order.

The covers 7 and 8 are divided into the front cover 7 and the rear cover 8 and are rotationally opened/closed in the front and rear directions by that the lower end portion of the front cover 7 and the approximate central portion of the rear cover 8 are all hinge-type coupled.

The body 1 is at the inner front side thereof disposed with a material supply roller 9 for feeding the material, which is supplied from the supply tray 3, toward the outlet 5. The material supply roller 9 is operated by the driving force of a driving motor 20.

The supply roller 9 is at one side thereof disposed with upper/lower standby rollers 10 and 10′ so that the continuously supplied material can maintain a standby state for a predetermined time period. The material supply roller 9 is at its one side disposed with a solenoid 28 and a supply clutch 29 so that the material served at the supply tray 3 can be in order supplied to the rollers 10 and 10′ according to the control of a microcomputer.

The body 1 is at its front lower side and at its rear upper side disposed with film drawing rollers 11 and 11′ for mounting the roll-type film F and is at its approximate central portion disposed with upper/lower heating roller 13 and 13′ for heating the film supplied from the film drawing rollers 11 and 11′ thereby to be coated the both sides of the material supplied from the rollers 10 and 10′. The material passes between the upper/lower heating rollers 13 and 13′. Each heating rollers 13 and 13′ is at its inside mounted with a heater not shown for increasing the surface temperature of the heating rollers 13 and 13′ to reach the predetermined temperature while being applied the power source. It is preferable that the heating rollers 13 and 13′ are manufactured with an aluminum having a good heat-conductivity so that a time for reaching the predetermined temperature can be shortened compared to the conventional steel.

Temperature sensors 14 and 14′ are disposed at a position contacting to a rubber enclosing the surface of the heating rollers 13 and 13′ so that the surface temperature preferably 110° in the present invention of the upper/lower heating roller 13 and 13′ can be constantly maintained and regulated.

Each temperature sensors 14 and 14′ is at its surface, that is, the surface contacted to the heating roller, attached with heat-resistant and abrasion-resistant resins 16 and 16′. Between the temperature sensors 14 and 14′ and the resins 16 and 16′, heat-resistant sponges 17 and 17′ are inserted. The temperature sensors 14 and 14′ are attached to sensor brackets 15 and 15′ having a hinge type. The sensor brackets 15 and 15′ are disposed with a torsion spring not shown for sensing the surface temperature of the rollers 13 and 13′ so that the surface temperature of the upper/lower heating rollers 13 and 13′ can be constantly maintained and that the vibration of the heating rollers 13 and 13′ is absorbed by the sponges 17 and 17′ and by the spring thereby to be constantly maintained the temperature against the outer shock and so on.

The supply inlet 2 is at its one side disposed with a material supply sensor 4. The upper/lower film drawing rollers 11 and 11′ are at their one side disposed with film sensors 12 and 12′ for sensing whether the film F is normally attached for feeding.

The upper/lower heating rollers 13 and 13′ are at their one side thereof closely disposed with upper/lower pressing rollers 18 and 18′ at a constant pressure for pressing and attaching the film to the material. The upper/lower pressing rollers 18 and 18′ are at their one side disposed with a fixing cutter 19 and a rotating cutter 19′ for cutting the coated material. The rotating cutter 19′ serves to arrange its timing for cutting the material in response to the inputted signal according to the size of the material.

A static electricity preventing brush 24 is disposed at the neighborhood of the upper/lower heating rollers 13 and 13′ and of the discharging rollers 23 and 23′ so that a static electricity generated due to the heat and the pressure for coating film to the material is prevented. The static electricity preventing brush 24 serves to prevent the deviation of the accumulating position due to the static electricity force generated when the coated material is accumulated at the discharging tray 16.

The upper film drawing roller 11, the heating roller 13, the pressing roller 18 and the fixing cutter 19 are secured to an upper supporting plate 21 which is hinge-type coupled to the one side of the rear surface of the body 1 thereby to be increased by a predetermined degree in the upward direction.

The lower film drawing roller 11′, the heating roller 13′, the pressing roller 18′ and the rotating cutter 19′ are secured to a lower supporting plate 21′ which is disposed to correspond to the upper supporting plate 21. The upper supporting plate 21 and the lower supporting plate 21′ must be disposed to constantly maintain their positions.

The body 1 is at its outlet disposed with a leading switch 26 and a counter 27 so that the number of coating of the material is counted to acknowledge the life of the components thereby to be exchanged the components which are finished their life.

An operation for coating the film to the material by the above-constructed coating apparatus will now be described.

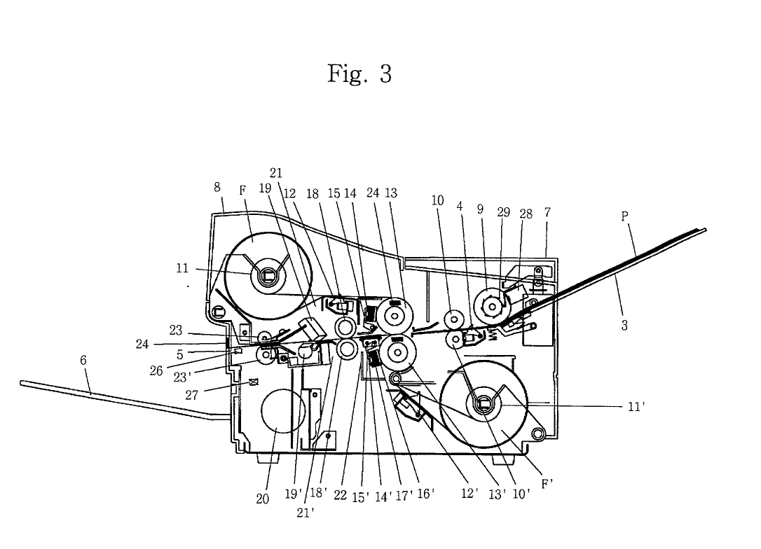

First, the upper roll film F is mounted at the film drawing roller 11 after the rear cover 8 is opened in the left direction of FIG. 3 and the lower roll film F′ is mounted at the film drawing roller 11′ after the front cover 7 is opened in the right direction.

Under this state, the upper supporting plate 21 is upwardly raised so that the upper roll film F encloses the upper heating roller 13 and so that the lower roll film F′ is located on the lower heating roller 13′.

Accordingly, the paralleled films F and F′ are passed through the guide plate 22, the pressing rollers 18 and 18′ and the cutters 19 and 19′ in order thereafter to pass the discharging rollers 23 and 23′.

Under this state, each roll films F and F′ is pulled to be discharged from the discharging outlet 5 of the body 1 through the discharging rollers 23 and 23′. Next, the user closes the front cover 7 and the rear cover 8 in order thereby to finish the mounting operation of the roll films F and F′.

These states serve to be mounted the roll films to the upper film drawing roller 11 and the lower film drawing roller 11′ so that the roll films are fed toward the discharging outlet 5 through the upper pressing roller 18 and the lower pressing roller 18′. At this time, each film sensors 12 and 12′ senses whether the roll films are correctly mounted at each film drawing rollers 11 and 11′.

As the result of that, if the film drawing roller 11 or the roller 11 ′ is not mounted or the films are all used during the operation, the lamp not shown is turned on for indicating whether the roll film exists or not.

Furthermore, if the material or the roll film is not normally fed or the cutters 19 and 19′ are not normally operated thereby causing the automatic cutting working not to be performed, the jump lamp is turned on so that the coating apparatus stops and the indication that the roll film must be mounted or there are some errors represents.

When the upper/lower heating rollers 13 and 13′ are their surface temperature reached to the predetermined temperature, approximately 110°, the lamp is turned on.

At this state, if the user presses the coating start button, the driving motor 20 rotates and the solenoid operates by the control of the microcomputer so that the clutch rotates thereby to apply the driving force to the supply roller 9. Accordingly, the paper is fed to the standby rollers 10 and 10′.

The paper fed to the standby rollers 10 and 10′ by the supply roller 9 maintains its state for a minute. At this state, The film is fused by the heating rollers 13 and 13′ corresponding to the preferable timing according to the signal of the sensor 4 thereby to be attached to the material. After, the material is passed through the pressing rollers 18 and 18′ thereby to be concretely pressed and is fed to the cutters 19 and 19′.

Accordingly, the cutters 19 and 19′ cut the film, which is attached to the both sides of the material, between 5-15 mm of the front end of the paper according to the paper front end signal.

The cut material coated with the film is automatically cut at the rear end 5-15 mm of the material according to the rear end signal of the material and passes the extract roller and the leading switch in order. At this time, the counter counts the signal from the lead switch thereby to be counted the number of coating in order.

The cut material coated with the film is fed to the tray 6 thereby to finish the process.

At this time, the static electricity of the material is removed at the time the material passes the static electricity preventing brush. Accordingly, the material which removed the static electricity is in order accumulated automatically without manual rearrange.

Meanwhile, in case when the roll film is not mounted or is all used, the roll film lamp is turned on to stop the operation of the roll laminator.

Furthermore, in case when the material or the roll film is not normally fed or the cutter is not normally operated, the jump lamp is turned on to stop the operation of the automatic roll laminator thereby to prevent the process error for coating.

As the foregoing descriptions, the present invention has the advantages that a cover is established to the body for being opened/closed and a heating roller and a pressing roller are closely detachably disposed thereby to be easy the mounting of the roll film and to easily perform the cleaning of the roller and inside of the apparatus and to easily perform the process when the jump lamp is turned on.

Furthermore, the material can be continuously supplied by manually or the supply tray to shorten the coating time and can be correctly cut to comply the user's desire by the automatic cutter.

Further, the body is at its inside disposed with the static electricity preventing brush to remove the static electricity generated due to the heat and the pressure applied to the material for forming a coating layer and the heating roller is manufactured with an aluminum to shorten the time for generating the heat necessary to coat.

Further, the counter is provided to manage the number of coating so that the number of use and life period can be correctly checked thereby to maximize the production efficiency by changing or repair of the components.

What is claimed is:

1. An automatic roll laminator comprising a body having a supply inlet formed at its front for supplying a material to be coated and an outlet formed at its rear for discharging the coated material, a supply roller disposed at one side of the supply inlet for feeding the material into the body, a film drawing roller for drawing a film mounted at the inside of the body to the both sides of material to be coated, a heating roller and a pressing roller disposed at the upper and lower portions to each other for heating and pressing the film to the material, wherein said body has its front and rear side with a hinge-type front cover and a rear cover, wherein said upper film drawing roller, said heating roller and said pressing roller are coupled to an upper supporting plate which is hinge-type coupled to the rear one side of the body to be upwardly slant by a predetermined degree.

2. The automatic roll laminator in accordance with claim 1, wherein a supply tray is disposed at the corresponding position to the supply inlet of the body and a solenoid and a supply clutch are disposed at one side of the supply roller so that the material served at the supply tray is in order fed to the standby roller,

3. The automatic roll laminator in accordance with claim 1, wherein a static electricity preventing brush is disposed at the neighborhood of the upper/lower heating roller and a discharging roller for removing a static electricity generated in the material.

4. The automatic roll laminator in accordance with claim 1, wherein a temperature sensor is attached at the surface of the upper/lower heating roller for maintaining and regulating the surface temperature of the heating roller.

5. The automatic roll laminator in accordance with claim 1, wherein said pressing roller is at its one side disposed with a fixing cutter fixedly established at the upper supporting plate and with a rotating cutter rotationally established at the lower supporting plate so that the coated material can be cut according to the user's desire.

6. The automatic roll laminator in accordance with claim 1, wherein said body is at its discharging outlet side disposed with a leading switch for sensing whether the cut material is fed and with a counter for counting the number of coating of the material.

7. The automatic roll laminator in accordance with claim 1, wherein said heating roller is manufactured with an aluminum.
